(19) United States
(12) Patent Application Publication
(10) Pub. No.: US 2025/0005437 A1
(43) Pub. Date: Jan. 2, 2025

(54) MACHINE LEARNING DEVICE, MACHINE LEARNING PROGRAM, SIMULATION DEVICE, AND SIMULATION PROGRAM

(71) Applicant: Nippon Telegraph and Telephone Corporation, Tokyo (JP)

(72) Inventors: Tomohiro KORIKAWA, Musashino-shi, Tokyo (JP); Chikako TAKASAKI, Musashino-shi, Tokyo (JP); Masafumi SHIMIZU, Musashino-shi, Tokyo (JP); Naoki TAKAYA, Musashino-shi, Tokyo (JP)

(21) Appl. No.: 18/291,072

(22) PCT Filed: Jul. 30, 2021
(86) PCT No.: PCT/JP2021/028454

§ 371 Date: Jan. 22, 2024

(51) Int. Cl. G06N 20/00

(52) U.S. Cl. CPC G06N 20/00

(57) ABSTRACT

A node model generation unit (2) includes a node setting unit (29) that inputs predetermined setting information to a node (11) of a network, a traffic generation unit (21) that applies predetermined traffic to the node (11) on the basis of predetermined applied traffic information, a performance measurement/capture unit (25) that acquires a performance measurement result obtained by measuring performance of the node (11) to which the predetermined setting information is set and to which the predetermined traffic is applied and captures (acquires) output traffic, a learning data input processing unit (24) that collects the predetermined setting information, the predetermined applied traffic information, a performance measurement result of the node (11), and the output traffic and registers the collected information as learning data, and a learning execution unit (27) that generates a node model of the node (11) by machine learning based on learning data registered by the learning data input processing unit (24).

### TECHNICAL FIELD

The present invention relates to a machine learning device, a machine learning program, a simulation device, and a simulation program for forming a network model for each configuration node of a communication network and performing simulation.

### BACKGROUND ART

For each configuration node of a communication network, a technology of modeling operation of the communication network or each node from input setting information and behavior for input traffic, for example, performance characteristics or statistical information has been disclosed. With this technology, a network model corresponding to a communication network can be formed using the communication network and a node model group obtained by modeling each node and simulation can be performed for various network configurations and input traffic.

Non Patent Literature 1 describes a technology of generating a network model for connection (network topology) between nodes included in a communication network. Non Patent Literature 2 describes a technology of constructing a performance prediction model of a single router included in a communication network.

### CITATION LIST

### Non Patent Literature

Non Patent Literature 1: K. Rusek, J. Suarez-Varela, P. Almasan, P. Barlet-Ros and A. Cabellos-Aparicio, “RouteNet: Leveraging Graph Neural Networks for Network Modeling and Optimization in SDN,” in IEEE Journal on Selected Areas in Communications, vol. 38, no. 10, pp. 2260-2270 October 2020, doi: 10.1109/JSAC.2020.3000405.
Non Patent Literature 2: Meyer, Torsten, Florian Wohlfart, Daniel Raumer, Bernd E. Wolfinger, and Georg Carle. 2014. “Validated Model-Based Performance Prediction of Multi-Core Software Routers.” PIK-Praxis Der Informationsverarbeitung Und Kommunikation 37 (2). https://doi.org/10.1515/pik-2014-0006.

### SUMMARY OF INVENTION

### Technical Problem

In order to study and control a better network configuration, a network model that accurately reflects network performance characteristics is required. The technology described in Non Patent Literature 1 has an issue that a network model cannot be generated in consideration of the internal configuration of a node, for example, the number and the length of queues, the processing speed, the number of times of parallel execution, and the like.

The technology described in Non Patent Literature 2 has an issue that modeling is not performed in consideration of a network topology and control protocol processing with neighboring nodes.

Therefore, an object of the present invention is to generate a network model in consideration of the internal configuration and control protocol processing of a node, and suitably perform simulation using the generated network model.

### Solution to Problem

In order to solve the above issue, a machine learning device of the present invention includes a node setting unit that inputs predetermined setting information to a node of a network, a traffic generation unit that applies predetermined traffic to the node on the basis of predetermined applied traffic information, a performance measurement unit that acquires a performance measurement result obtained by measuring performance of the node to which the predetermined setting information is set and to which the predetermined traffic is applied and output traffic, a learning data input processing unit that collects any one or more of the predetermined setting information, the predetermined applied traffic information, the performance measurement result of the node, and the output traffic and registers the collected information as learning data, and a learning execution unit that generates a node model of the node by machine learning based on learning data registered by the learning data input processing unit.

Other means will be described in Description of Embodiments.

### Advantageous Effects of Invention

According to the present invention, a network model can be generated in consideration of the internal configuration and control protocol processing of a node, and simulation can be suitably performed using the generated network model.

### BRIEF DESCRIPTION OF DRAWINGS

FIG. 1 is an overall configuration diagram of a machine learning device and a simulation device according to the present embodiment.

FIG. 2 is a flowchart of processing of generating a node model by machine learning for a target network node and connecting a plurality of generated node models to form a network model.

FIG. 3A is a flowchart of processing (part 1) of generating a node model by machine learning using input setting information, applied traffic information, a performance measurement result, information of output traffic, and information that can be acquired from a network node as learning data in a case where a certain setting information pattern is input to the node and traffic is applied on the basis of certain applied traffic information.

FIG. 3B is a flowchart of processing (part 2) of generating a node model by machine learning using input setting information, applied traffic information, a performance measurement result, information of output traffic, and information that can be acquired from a network node as learning data in a case where a certain setting information pattern is input to the node and traffic is applied on the basis of certain applied traffic information.

FIG. 4A is a flowchart of processing (part 1) of forming a network model by connecting several generated node models according to setting information of each node in a certain network configuration.

FIG. 4B is a flowchart of processing (part 2) of forming a network model by connecting several generated node models according to setting information of each node in a certain network configuration.

### DESCRIPTION OF EMBODIMENTS

Hereinafter, an embodiment for implementing the present invention will be described in detail with reference to the drawings.

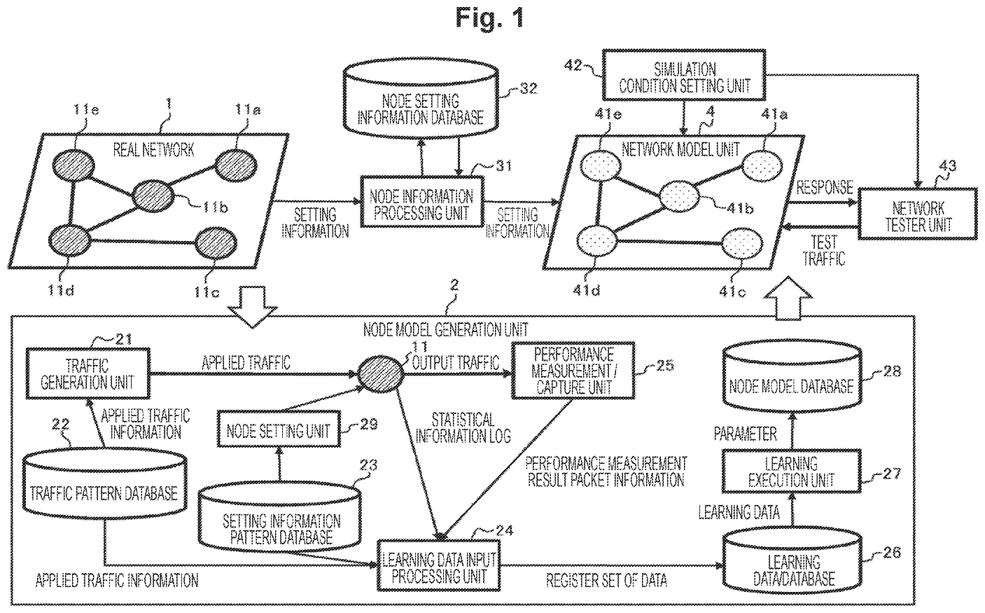

FIG. 1 is an overall configuration diagram of a machine learning device and a simulation device according to the present embodiment.

A node model generation unit 2 illustrated in FIG. 1 is a machine learning device that generates node models 41a to 41e corresponding to respective actual nodes 11a to 11e included in a real network 1 by machine learning. Here, the nodes 11a to 11e are servers, routers, switches, and the like. The machine learning device is, for example, a computer including a central processing unit (CPU) and a memory. The CPU of the machine learning device implements the node model generation unit 2 and a node information processing unit 31 by executing a machine learning program (not illustrated).

The node model generation unit 2 includes a traffic generation unit 21, a traffic pattern database 22, a setting information pattern database 23, a learning data input processing unit 24, a performance measurement/capture unit 25, a learning data/database 26, a learning execution unit 27, a node model database 28, and a node setting unit 29. The node model generation unit 2 generates the node models 41a to 41e reflecting network performance characteristics for the nodes 11a to 11e included in the real network 1. The node models 41a to 41e include inference devices that infer the operation and performance of the respective actual nodes 11a to 11e. Therefore, the node model generation unit 2 selects a node 11 that is one of the actual nodes 11a to 11e, and measures the performance of the node 11.

The traffic pattern database 22 is a database that stores, for example, M patterns of applied traffic information. Here, the applied traffic information refers to a packet length, a protocol, and an applied rate of traffic. The traffic generation unit 21 reads any one piece of the applied traffic information of the traffic pattern database 22 and applies traffic to the node 11 on the basis of the applied traffic information.

The setting information pattern database 23 is a database that stores, for example, L patterns of setting information. Here, the setting information is information input to the node 11 to operate the node 11, and includes, for example, whether each port included in the network interface is used, a filter function, a routing function, and setting values of a band control function and a priority control function. The setting information pattern is a variation of various setting values included in the setting information. The node setting unit 29 reads any one piece of the setting information and inputs the read setting information to the node 11 that is a model generation target.

The performance measurement/capture unit 25 is a performance measurement unit that acquires (captures) a performance measurement result obtained by measuring the performance of the node 11 and output traffic. The performance measurement/capture unit 25 acquires a performance measurement result obtained by measuring the performance of the node 11 as a black box. Then, the performance measurement/capture unit 25 acquires (captures) output traffic of the node 11. As a result, the performance measurement/capture unit 25 measures performance when traffic based on predetermined applied traffic information is applied to the node 11 to which predetermined setting information is set, and captures traffic at that time.

The learning data input processing unit 24 collects applied traffic information serving as a base of traffic applied to the node 11 by the traffic generation unit 21 from the traffic pattern database 22, and collects setting information input to the node 11 by the node setting unit 29 from the setting information pattern database 23. The learning data input processing unit 24 further collects statistical information and log information from the node 11, and collects a set of a performance measurement result and packet capture information of the node 11 from the performance measurement/capture unit 25. The learning data input processing unit 24 registers the collected data set (learning data) in the learning data/database 26. Note that the statistical information collected by the learning data input processing unit 24 from the node 11 is, for example, a CPU usage rate, a queue usage rate, and the like. The log information collected by the learning data input processing unit 24 from the node 11 is, for example, an error log and the like.

The learning execution unit 27 generates a node model including an inference device that infers the performance of the node 11 and output a packet by machine learning on the basis of a data set (learning data) including input setting information, applied traffic information, a performance measurement result of the node 11, and output traffic of the node 11 registered in the learning data/database 26.

A case where the node setting unit 29 inputs a setting information pattern regarding whether each port included in a network interface of the node 11 is input to the node 11 is considered. At this time, the learning data input processing unit 24 collects applied traffic information serving as a base of traffic applied to the node 11 from the traffic pattern database 22, and collects setting information input to the node 11 regarding whether each port included in the network interface of the node 11 is used from the setting information pattern database 23. The learning data input processing unit 24 further collects statistical information and log information from the node 11, and collects a set of a performance measurement result and packet capture information of the node 11 from the performance measurement/capture unit 25. The learning data input processing unit 24 registers the collected data set in the learning data/database 26. The learning execution unit 27 generates a node model of the node 11 by machine learning based on learning data including a setting information pattern regarding whether each port included in the network interface of the node 11 is used obtained as described above. In this way, a network model is generated in consideration of whether each port included in the network interface of the node is used.

Furthermore, a case where the traffic generation unit 21 applies traffic including a packet group according to a predetermined communication protocol to the node 11 is considered. At this time, the learning data input processing unit 24 collects applied traffic information serving as a base of traffic applied to the node 11 from the traffic pattern database 22, and collects setting information input to the node 11 from the setting information pattern database 23. The learning data input processing unit 24 further collects statistical information and log information from the node 11, and collects a set of a performance measurement result and packet capture information of the node 11 from the performance measurement/capture unit 25. The learning data input processing unit 24 registers the collected data set in the learning data/database 26. The learning execution unit 27 generates a node model of the node 11 by machine learning based on learning data including the traffic including the packet group according to the predetermined communication protocol obtained as described above. In this way, a network model can be generated in consideration of control protocol processing of a node.

In addition to collecting applied traffic information serving as a base of traffic applied to the node 11 from the traffic pattern database 22, collecting setting information input to the node 11, collecting statistical information and log information from the node 11 from the setting information pattern database 23, and collecting a set of a performance measurement result and packet capture information of the node 11 from the performance measurement/capture unit 25, the learning data input processing unit 24 may extract time information of each packet input/output of the node 11 on the basis of the packet capture information collected from the performance measurement/capture unit 25, and register the data set in the learning data/database 26. Here, the time information of each packet input/output is, for example, a time stamp at the time of each packet input/output. On the basis of the above learning data, the learning execution unit 27 learns a processing time required for packet processing in the node 11 under a predetermined condition from information of a time of each packet input/output of the node 11 when predetermined traffic is applied to the node 11, and generates a node model of the node 11. In this way, the learning execution unit 27 generates a network model in consideration of a processing time inside a node. Note that the learning execution unit 27 is not limited to extracting time information of each packet input/output of the node 11 on the basis of a time stamp at the time of each packet input/output, and may learn a processing time required for packet processing in the node 11 under a predetermined condition using a time at the time of each packet capture as the time information of each packet input/output.

The node model generated by the learning execution unit 27 is registered in the node model database 28. Note that the learning execution unit 27 may generate the node model of the node by machine learning on the basis of learning data including a setting information pattern, an applied traffic pattern, a performance measurement result, output traffic, and information that can be acquired from the node. The information that can be acquired from the node refers to statistical information or log information collected by the learning data input processing unit 24 from the node. The learning execution unit 27 improves the accuracy of simulation as more information among the setting information pattern, the applied traffic pattern, the performance measurement result, the output traffic, and the information that can be acquired from the node is used as learning data, but one or a plurality of pieces of information may be missing.

A network model unit 4 forms a network model by virtually connecting the node models 41a to 41e. Here, the computer that develops the node models 41a to 41e is a simulation device. The CPU of this computer executes a simulation program, thereby implementing the network model unit 4, the node information processing unit 31, a simulation condition setting unit 42, and a network tester unit 43.

The simulation device includes the node information processing unit 31, the simulation condition setting unit 42, and the network tester unit 43, and operates the virtually formed network model unit 4 to execute simulation. That is, the simulation device simulates operation of each of the node models included in the network model and communication between the node models when traffic is applied to the network model.

The node information processing unit 31 collects setting information from each of the nodes 11a to 11e included in the real network 1, registers the setting information in a node setting information database 32, and sets the registered setting information in the node models 41a to 41e. Here, the setting information collected from the nodes 11a to 11e is information input to the respective nodes to operate each of the nodes 11a to 11e as the real network 1, and includes, for example, whether each port included in the network interface is used, a filter function, a routing function, setting values of a band control function and a priority control function, and the like. As a result, the network model unit 4 performs modeling in consideration of the network topology and control protocol processing with neighboring nodes.

The simulation condition setting unit 42 sets a simulation condition of the network model, such as with what data as input each of the node models of the network model unit 4 operates and which value is estimated on the basis of input data. Specifically, the simulation condition setting unit 42 sets, as a simulation condition, any one of a statistical mode in which statistical information of input traffic is input and a packet mode in which information of a packet included in input traffic is input in the node models included in the network model.

The network tester unit 43 is a tester unit that determines whether the simulation condition is the statistical mode or the packet mode, applies traffic corresponding to the simulation condition to a node model included in the network model, receives the response traffic at that time, and displays performance measurement result information, or receives a packet and displays the received packet information. That is, in a case where the simulation condition is the statistical mode, the network tester unit 43 applies statistical information of traffic to a node model included in the network model.

Furthermore, in a case where the simulation condition is the packet mode, the network tester unit 43 applies information of an input packet to a node model included in the network model.

Note that the network tester unit 43 includes a plurality of ports, and is not limited to a case of being connected to one node in the network model and applying traffic, and may be connected to two or more different nodes and applying traffic.

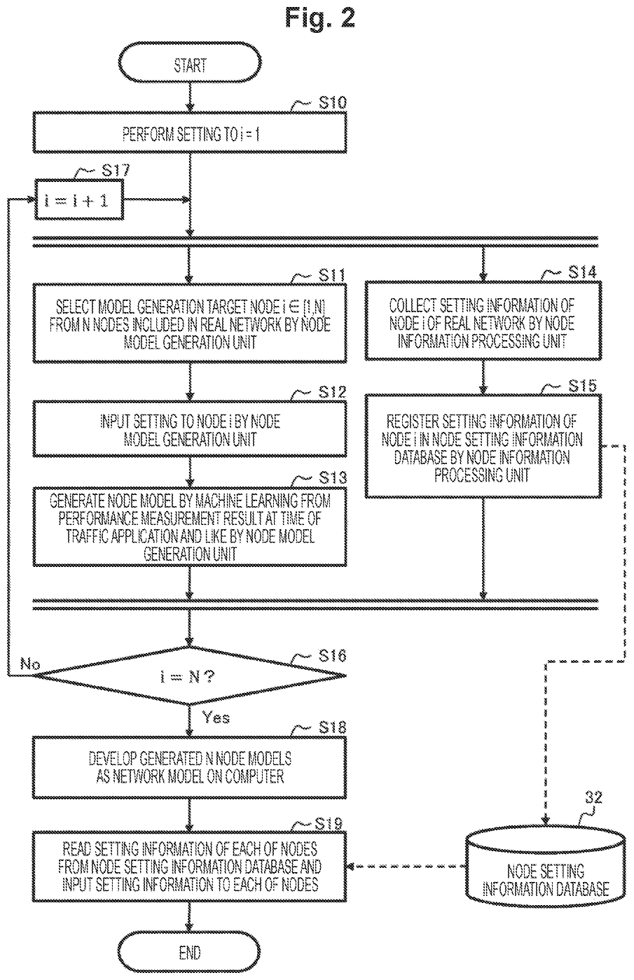

FIG. 2 is a flowchart of processing of generating a node model by machine learning for a target network node and connecting a plurality of generated node models to form a network model.

First, the CPU of the machine learning device initializes a variable i to 1 (step S10), and executes processing of the node model generation unit 2 and processing of the node information processing unit 31 in parallel. That is, processing of steps S11 to S13 and processing of steps S14 and S15 are executed in parallel. As a result, simulation can be executed at a high speed.

The node model generation unit 2 selects a model generation target node i∈[1, N] from the N nodes 11a to 11e included in the real network 1 (step S11), and inputs a setting to the selected node i (step S12). Then, the node model generation unit 2 generates a node model by machine learning from a performance measurement result at the time of traffic application and the like (step S13).

The model generation processing may be executed in parallel for a plurality of nodes simultaneously by a plurality of node model generation units 2 being prepared.

The node information processing unit 31 collects setting information of the node i of the real network 1 (step S14). Here, the setting information collected from the node i of the real network 1 is information input to the node i to operate the node i as the real network 1, and includes, for example, whether each port included in the network interface is used, a filter function, a routing function, setting values of a band control function and a priority control function, and the like. The node information processing unit 31 registers the collected setting information of the node i in the node setting information database 32 (step S15).

Next, the CPU of the machine learning device determines whether the variable i is equal to N that is the number of nodes included in the real network 1 (step S16). In a case where the variable i is not equal to N (No), 1 is added to the variable i (step S17), and the CPU repeats the parallel processing of steps S11 to S13 and steps S14 and S15. In a case where the variable i is equal to N, the CPU proceeds to processing of step S18.

The network model unit 4 develops generated N node models on the computer (step S18). Then, when the network model unit 4 reads setting information of each of the nodes from the node setting information database 32 and inputs the setting information to each of the nodes (step S19), the processing of FIG. 2 ends. As a result, the network model unit 4 can generate a network model in consideration of the internal configuration and control protocol processing of a node.

Here, the computer that develops the node models is a simulation device. The simulation device and the machine learning device may be the same computer, but are not limited thereto, and may be two computers that can communicate with each other.

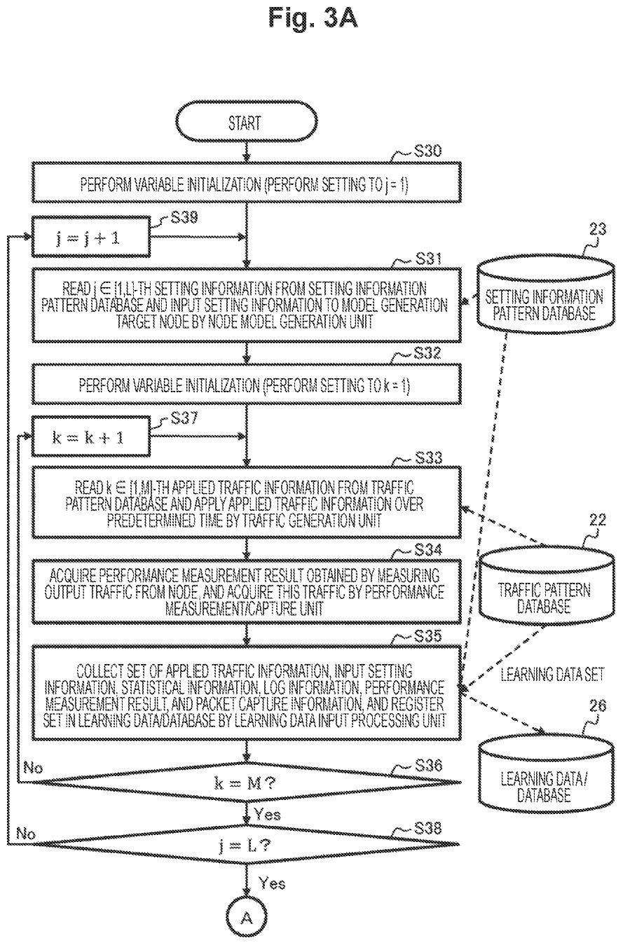

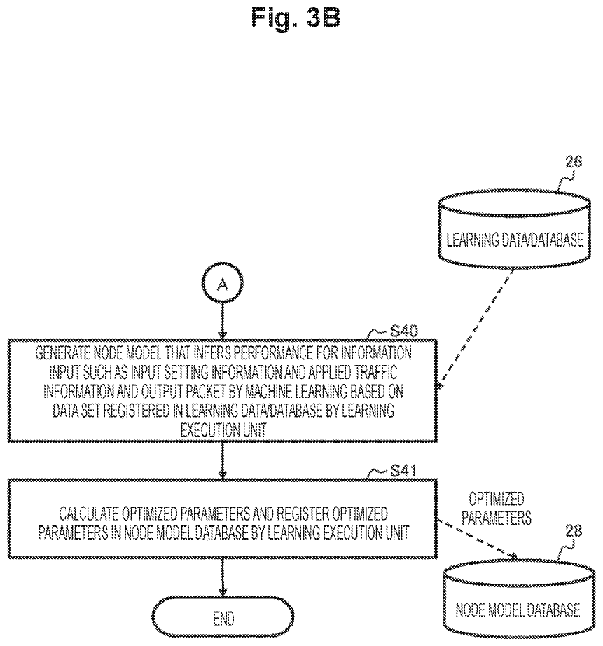

FIGS. 3A and 3B are flowcharts of processing of generating a node model by machine learning using input setting information, applied traffic information, a performance measurement result, information of output traffic, and information that can be acquired from any one of N network nodes as learning data in a case where a certain setting information pattern is input to the node and traffic is applied on the basis of certain applied traffic information.

Note that, as a precondition, L patterns of setting information are registered in the setting information pattern database 23, and M patterns of applied traffic information are registered in the traffic pattern database 22. In this processing, simulation of L*M patterns obtained by combining L pieces of setting information and M pieces of applied traffic information is executed.

First, the node model generation unit 2 initializes a variable j to 1 (step S30). Then, the node setting unit 29 of the node model generation unit 2 reads the j∈[1, L]-th setting information from the setting information pattern database 23 and inputs the setting information to the model generation target node 11 (step S31). Here, the setting information is information input to the node 11 to operate the node 11, and includes, for example, whether each port included in the network interface is used, a filter function, a routing function, and setting values of a band control function and a priority control function. The setting information pattern is a variation of various setting values included in the setting information.

The node model generation unit 2 initializes a variable k to 1 (step S32). Then, the traffic generation unit 21 reads the k∈[1, M]-th applied traffic information from the traffic pattern database 22 and applies the applied traffic information to the model generation target node 11 over a predetermined time (step S33). Here, the applied traffic information refers to a packet length, a protocol, and an applied rate of traffic. As a result, traffic based on the k-th applied traffic information can be applied to the model generation target node 11 to which the j-th setting information has been input.

Next, the performance measurement/capture unit 25 acquires a performance measurement result obtained by measuring output traffic from the model generation target node 11, and captures (acquires) this traffic (step S34).

Then, the learning data input processing unit 24 collects applied traffic information serving as a base of the traffic applied to the model generation target node 11 from the traffic pattern database 22, and collects setting information input to the model generation target node 11 from the setting information pattern database 23. Then, the learning data input processing unit 24 collects statistical information and log information from the model generation target node 11, collects the performance measurement result and packet capture information from the performance measurement/capture unit 25, and registers these pieces of information in the learning data/database 26 (step S35). Note that the statistical information collected by the learning data input processing unit 24 from the node 11 is, for example, a CPU usage rate, and a queue usage rate. The log information collected by the learning data input processing unit 24 from the node 11 is an error log and the like.

Next, the node model generation unit 2 determines whether the variable k is equal to M that is the number of patterns of the applied traffic information (step S36). In a case where the variable k is different from M (No), the node model generation unit 2 adds 1 to the variable k (step S37), and then returns to step S33. In a case where the variable k is equal to M (Yes), the node model generation unit 2 proceeds to step S38.

In step S38, the node model generation unit 2 determines whether the variable j is equal to L that is the number of setting information patterns. In a case where the variable j is different from L (No), the node model generation unit 2 adds 1 to the variable j (step S39), and then returns to step S31. In a case where the variable j is equal to L (Yes), the node model generation unit 2 proceeds to step S40.

In step S40, the learning execution unit 27 generates a node model including an inference device that infers statistical performance for information input such as input setting information and applied traffic information and an output packet for an individual input packet by machine learning based on a data set (learning data) registered in the learning data/database 26. Upon calculating optimized parameters and registering the optimized parameters in the node model database 28 (step S41), the learning execution unit 27 ends the processing of FIG. 3B.

In the processing of FIGS. 3A and 3B, the node model generation unit 2 performs machine learning on the basis of an actual machine measurement result of the performance and operation of a network node, and generates a node model including an inference device that infers the performance and operation of the node. As a result, it is expected that simulation operation is performed at a higher speed than a conventional simulator technology in consideration of the internal structure of a node, for example, the number of processor cores, the memory amount, the number of queues, the queue length, and the like.

Here, the machine learning performed by the learning execution unit 27 may be changed in accordance with the content or amount of the data set. The learning execution unit 27 may perform deep learning, or may perform conventional machine learning such as a non-deep learning neural network or regression analysis.

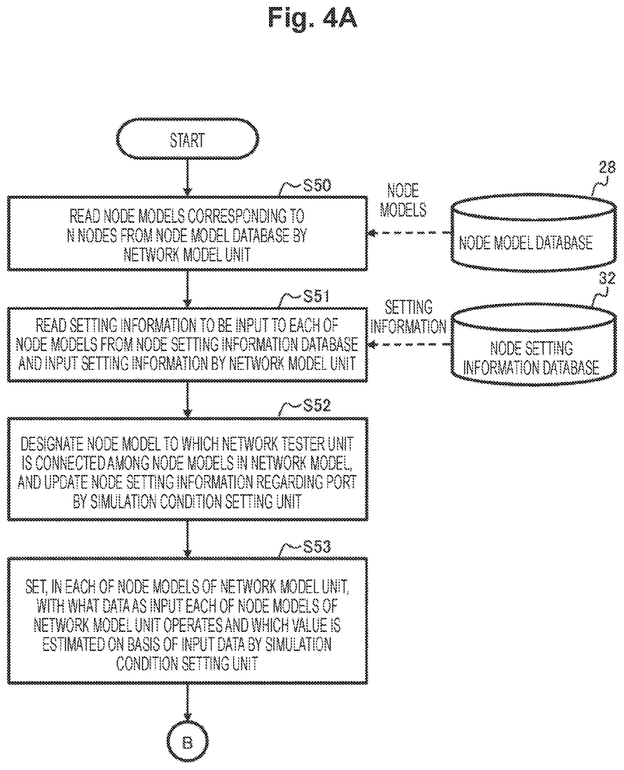

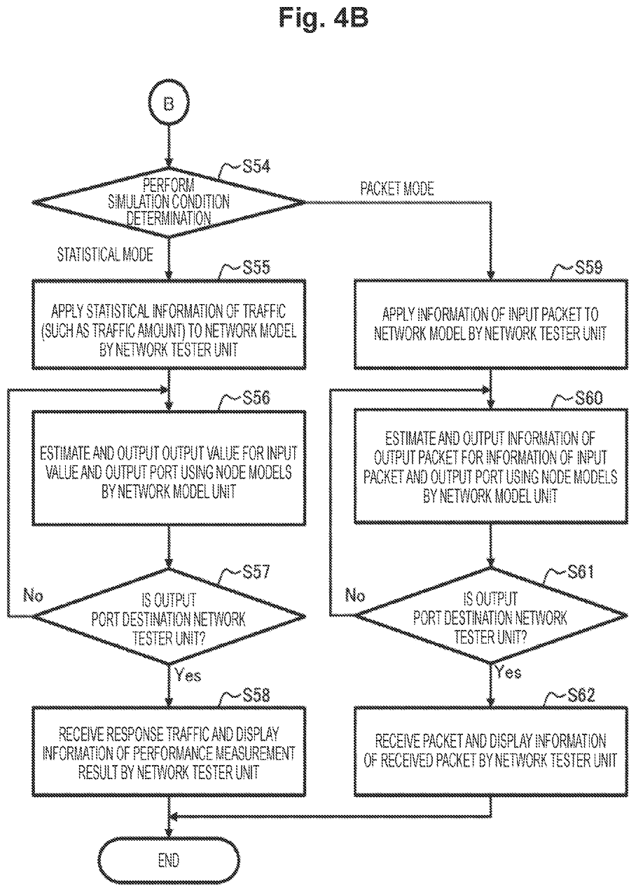

FIGS. 4A and 4B are flowcharts of processing of forming a network model by connecting several generated node models according to setting information of each node in a certain network configuration.

Upon starting the processing, the network model unit 4 reads node models corresponding to N nodes from the node model database 28 (step S50).

Then, the network model unit 4 reads setting information to be input to each of the node models by the node information processing unit 31 from the node setting information database 32 and inputs the setting information to each of the node models (step S51). As a result, the network model unit 4 forms a network model using a network node group including inference devices that infer the operation and performance of the actual nodes 11a to 11e. This network model may be able to perform simulation of the entire network at a higher speed than a conventional simulator technology. Here, the setting information that the network model unit 4 inputs to each of the node models is information that has been input to each of the nodes to operate each of the nodes 11a to 11e as the real network 1, and includes, for example, whether each port included in the network interface is used, a filter function, a routing function, setting value link information of a band control function and a priority control function, a setting of a routing protocol, and the like.

The simulation condition setting unit 42 designates a node model to which the network tester unit 43 is connected among the node models of the network model unit 4, and updates node setting information regarding a port (step S52). The simulation condition setting unit 42 further sets, in each of the node models, with what data as input each of the node models of the network model unit 4 operates and which value is estimated on the basis of input data (step S53).

Then, the network tester unit 43 determines whether the simulation condition is the statistical mode or the packet mode. The network tester unit 43 proceeds to step S55 in a case where the simulation condition is the statistical mode, and proceeds to step S59 in a case where the simulation condition is the packet mode.

In step S55, the network tester unit 43 applies statistical information of traffic (such as a traffic amount) to the node models of the network model unit 4. Then, the network model unit 4 estimates and outputs an output value for an input value (statistical information of output traffic) and an output port using the node models (step S56).

In the output port estimation, the setting information input to the node models is assumed to be input of the inference devices. However, the estimation is not limited thereto, and input of the inference devices may be stochastically determined by a weighted random number being generated in consideration of the setting information input to the node models, the band of the inter-node link, and the like.

The description will be continued with reference to FIG. 4B. The network model unit 4 determines whether the output port destination is the network tester unit 43 (step S57). In a case where the output port destination is not the network tester unit 43 (No), the network model unit 4 returns to step S56, and in a case where the output port destination is the network tester unit 43 (Yes), the network model unit 4 proceeds to step S58.

Upon receiving response traffic (statistical information) and displaying information of a performance measurement result in step S58, the network tester unit 43 ends the processing of FIG. 4B. By the simulation condition being set to the statistical mode, statistical information of output traffic of each of the node models when traffic is applied using the network model can be suitably simulated. Since the network model unit 4 macroscopically simulates the statistical information of the output traffic of each of the node models, it is expected that a discard rate, a throughput, a delay, and the like for input traffic can be evaluated at a high speed.

In step S59, the network tester unit 43 applies information of an input packet to the node models of the network model unit 4. The network tester unit 43 inputs information necessary for inference as the packet information. The network tester unit 43 may input a packet itself to the node models, or may input a protocol or a size that is a feature of the packet, a value of a certain field in the packet header, and the like.

Then, the network model unit 4 estimates and outputs information of an output packet for information of an input packet and an output port using the node models (step S60).

The network model unit 4 determines whether the output port destination is the network tester unit 43 (step S61). In a case where the output port destination is not the network tester unit 43 (No), the network model unit 4 returns to step S60, and in a case where the output port destination is the network tester unit 43 (Yes), the network model unit 4 proceeds to step S62.

Upon receiving a packet and displaying information of the received packet in step S62, the network tester unit 43 ends the processing of FIG. 4B. By the simulation condition being set to the packet mode, the network model unit 4 suitably simulates the operation of each of the node models for each input packet and the communication between the node models when traffic is applied using the network model, and thus, it is expected that the behavior of each of the node models and the network model can be precisely confirmed.

By the processing of FIGS. 4A and 4B, in the present embodiment, the operation of each of the node models and the communication between the node models can be suitably simulated using the network model in consideration of the internal configuration and control protocol processing of a node.

### (Effects of Present Embodiment)

The node model generation unit 2 of the present embodiment described above performs machine learning on the basis of a performance measurement result of a network node and an actual machine measurement result such as output traffic of a node, and generates a node model including an inference device reflecting the performance measurement result, the output traffic, and the like. As a result, it is expected that simulation operation is performed at a higher speed than a conventional simulator technology in consideration of the internal structure of a node, for example, the number of processor cores, the memory amount, the number of queues, the queue length, and the like.

The network model unit 4 of the present embodiment forms a network model using a network node group including inference devices. As a result, simulation of the entire network may be able to be performed at a higher speed than a conventional simulator technology.

In the present embodiment, in a case where simulation of a network including a large number of network nodes is necessary, a network model includes a network node group including inference devices based on a measurement result of an actual machine. As a result, simulation of the entire network can be performed without a large amount of actual machines as network nodes prepared, and there is a possibility that the cost and the period can be reduced as compared with experiments using actual machines.

### Modification Examples

The present invention is not limited to the above embodiment, and can be modified without departing from the gist of the present invention. For example, the following (a) and (b) are provided.
(a) The real network 1 to be subjected to the model generation processing may not physically exist. In a case where the real network 1 does not physically exist, setting information that can be input to each of the nodes included in the real network 1 is sufficient.
(b) In the network model configuration, a generation node model may be incorporated in an existing network simulator or the like, and an existing node model and the generation node model may be combined. In that case, it is conceivable to execute simulation by converting an input value to the opposite node into a suitable format between the generation node model and the existing node model.

### <<Effects>>

Hereinafter, a configuration and effects of the machine learning device and the like according to the present invention will be described.

The invention according to claim 1 is a machine learning device including a node setting unit that inputs predetermined setting information to a node of a network, a traffic generation unit that applies predetermined traffic to the node on the basis of predetermined applied traffic information, a performance measurement unit that acquires a performance measurement result obtained by measuring performance of the node to which the predetermined setting information is set and to which the predetermined traffic is applied and output traffic, a learning data input processing unit that collects any one or more of the predetermined setting information, the predetermined applied traffic information, the performance measurement result of the node, and the output traffic and registers the collected information as learning data, and a learning execution unit that generates a node model of the node by machine learning based on learning data registered by the learning data input processing unit.

In this way, a network model can be generated in consideration of the internal configuration and control protocol processing of a node.

The invention according to claim 2 is the machine learning device according to claim 1, in which the node setting unit inputs a setting information pattern regarding whether each port included in a network interface of the node is used to a corresponding node, the performance measurement unit acquires a performance measurement result obtained by measuring performance of the node and output traffic, the learning data input processing unit further collects statistical information or log information from the node and registers the statistical information or the log information as learning data, and the learning execution unit generates a node model of the node by machine learning based on learning data including the setting information pattern regarding whether each port included in the network interface of the node is used and statistical information or log information collected from the node.

In this way, a network model can be generated in consideration of whether each port included in a network interface of a node is used.

The invention according to claim 3 is the machine learning device according to claim 1, in which the traffic generation unit applies traffic including a packet group according to a predetermined communication protocol to the node, the performance measurement unit acquires a performance measurement result obtained by measuring performance of the node to which the predetermined traffic is applied and output traffic, the learning data input processing unit further collects statistical information or log information from the node and registers the statistical information or the log information as learning data, and the learning execution unit generates a node model of the node by machine learning based on learning data including traffic including packet group according to predetermined communication protocol and statistical information or log information collected from the node.

In this way, a network model can be generated in consideration of control protocol processing of a node.

The invention according to claim 4 is the machine learning device according to claim 1, in which the learning data input processing unit further extracts time information of each packet input/output of the output traffic collected from the performance measurement unit and registers the time information as learning data, and the learning execution unit generates a node model of the node by learning a time required for packet processing in the node under a predetermined condition on the basis of the time information.

In this way, a network model can be generated in consideration of a packet processing time inside a node.

The invention according to claim 5 is a machine learning program, in a computer, including a procedure of inputting predetermined setting information to a node of a network, a procedure of applying predetermined traffic to the node on the basis of predetermined applied traffic information, a procedure of acquiring a performance measurement result obtained by measuring performance of the node to which the predetermined setting information is set and to which the predetermined traffic is applied and output traffic, and a procedure of generating a node model of the node by machine learning based on learning data including the predetermined setting information, the predetermined applied traffic information, performance of the node, and the output traffic.

In this way, a network model can be generated in consideration of the internal configuration and control protocol processing of a node.

The invention according to claim 6 is a simulation device including a network model unit that connects a plurality of node models according to setting information of each node in a network configuration and forms a network model, a setting unit that sets a simulation condition of the network model, and a tester unit that applies traffic corresponding to the simulation condition to node models included in the network model.

In this way, the operation of each of the node models and the communication between the node models when traffic is applied to the network model can be suitably simulated using the network model in consideration of the internal configuration and control protocol processing of a node.

The invention according to claim 7 is the simulation device according to claim 6, in which the setting unit sets a simulation condition using statistical information of input traffic as input for the node models included in the network model, and the tester unit applies statistical information of traffic to node models included in the network model.

In this way, statistical information of output traffic of each of the node models when traffic is applied using the network model can be suitably simulated. Since the statistical information of the output traffic of each of the node models is macroscopically simulated, it is expected that a discard rate, a throughput, a delay, and the like for input traffic can be evaluated at a high speed.

The invention according to claim 8 is the simulation device according to claim 6, in which the setting unit sets a simulation condition using information of a packet included in input traffic as input for the node models included in the network model, and the tester unit applies information of an input packet to the node models included in the network model.

In this way, the operation of each of the node models for each input packet and the communication between the node models when traffic is applied using the network model can be suitably simulated, and it is expected that the behavior of each of the node models and the network model can be precisely confirmed.

The invention according to claim 9 is a simulation program for causing a computer to execute procedures, the procedures including a procedure of connecting a plurality of node models according to setting information of each node in a network configuration and forming a network model, a procedure of setting a simulation condition of the network model, a procedure of applying traffic corresponding to the simulation condition to node models included in the network model, and a procedure of simulating operation of each of the node models included in the network model and communication between the node models when the traffic is applied to the network model.

In this way, the operation of each of the node models and the communication between the node models can be suitably simulated using the network model in consideration of the internal configuration and control protocol processing of a node.

### REFERENCE SIGNS LIST

1 Real network
11a to 11e, 11 Node
2 Node model generation unit
21 Traffic generation unit
22 Traffic pattern database
23 Setting information pattern database
24 Learning data input processing unit
25 Performance measurement/capture unit (Performance measurement unit)
26 Learning data/database
27 Learning execution unit
28 Node model database
29 Node setting unit
31 Node information processing unit
32 Node setting information database
4 Network model unit
418 to 41e Node model
42 Simulation condition setting unit (setting unit)
43 Network tester unit (tester unit)

1. A machine learning device comprising:
a node setting unit, including one or more processors, configured to input predetermined setting information to a node of a network;
a traffic generation unit, including one or more processors, configured to apply predetermined traffic to the node on a basis of predetermined applied traffic information;
a performance measurement unit, including one or more processors, configured to acquire a performance measurement result obtained by measuring performance of the node to which the predetermined setting information is set and to which the predetermined traffic is applied and output traffic;
a learning data input processing unit, including one or more processors, configured to collect any one or more of the predetermined setting information, the predetermined applied traffic information, the performance measurement result of the node, and the output traffic and register the collected information as learning data; and
a learning execution unit, including one or more processors, configured to generate a node model of the node by machine learning based on the learning data registered by the learning data input processing unit.

2. The machine learning device according to claim 1,
wherein the node setting unit is configured to input a setting information pattern regarding whether each port included in a network interface of the node is used to a corresponding node,
the performance measurement unit is configured to acquire a performance measurement result obtained by measuring performance of the node and output traffic,
the learning data input processing unit is further configured to collect statistical information or log information from the node and register the statistical information or the log information as learning data, and
the learning execution unit is configured to generate a node model of the node by machine learning based on learning data including the setting information pattern regarding whether each port included in the network interface of the node is used and statistical information or log information collected from the node.

3. The machine learning device according to claim 1,
wherein the traffic generation unit is configured to apply traffic including a packet group according to a predetermined communication protocol to the node,
the performance measurement unit is configured to acquire a performance measurement result obtained by measuring performance of the node to which the predetermined traffic is applied and output traffic,
the learning data input processing unit is further configured to collect statistical information or log information from the node and register the statistical information or the log information as learning data, and
the learning execution unit is configured to generate a node model of the node by machine learning based on learning data including traffic including packet group according to predetermined communication protocol and statistical information or log information collected from the node.

4. The machine learning device according to claim 1,
wherein the learning data input processing unit is further configured to extract time information of each packet input/output of the output traffic collected from the performance measurement unit and register the time information as learning data, and
the learning execution unit is configured to generate a node model of the node by learning a time required for packet processing in the node under a predetermined condition on a basis of the time information.

5. A non-transitory storage medium storing a machine learning program that causes a computer to perform operations comprising:
inputting predetermined setting information to a node of a network;
applying predetermined traffic to the node on a basis of predetermined applied traffic information;
acquiring a performance measurement result obtained by measuring performance of the node to which the predetermined setting information is set and to which the predetermined traffic is applied and output traffic; and
generating a node model of the node by machine learning based on learning data including the predetermined setting information, the predetermined applied traffic information, performance of the node, and the output traffic.

6. A simulation device comprising:
a network model unit, including one or more processors, configured to connect a plurality of node models according to setting information of each node in a network configuration and forms a network model;
a setting unit, including one or more processors, configured to set a simulation condition of the network model; and
a tester unit, including one or more processors, configured to apply traffic corresponding to the simulation condition to node models included in the network model.

7. The simulation device according to claim 6,
wherein the setting unit is configured to set a simulation condition using statistical information of input traffic as input for the node models included in the network model, and
the tester unit is configured to apply statistical information of traffic to node models included in the network model.

8. The simulation device according to claim 6,
wherein the setting unit is configured to set a simulation condition using information of a packet included in input traffic as input for the node models included in the network model, and
the tester unit is configured to apply information of an input packet to the node models included in the network model.

9. A non-transitory storage medium storing a simulation program for causing a computer to execute procedures to function as the simulation device according to claim 6.

10. The non-transitory storage medium according to claim 5, wherein the operations further comprise:
inputting a setting information pattern regarding whether each port included in a network interface of the node is used to a corresponding node;
acquiring a performance measurement result obtained by measuring performance of the node and output traffic;
collecting statistical information or log information from the node and registers the statistical information or the log information as learning data; and
generating a node model of the node by machine learning based on learning data including the setting information pattern regarding whether each port included in the network interface of the node is used and statistical information or log information collected from the node.

11. The non-transitory storage medium according to claim 5, wherein the operations further comprise:
applying traffic including a packet group according to a predetermined communication protocol to the node;
acquiring a performance measurement result obtained by measuring performance of the node to which the predetermined traffic is applied and output traffic;
collecting statistical information or log information from the node and registering the statistical information or the log information as learning data; and
generating a node model of the node by machine learning based on learning data including traffic including packet group according to predetermined communication protocol and statistical information or log information collected from the node.

12. The non-transitory storage medium according to claim 5, wherein the operations further comprise:
extracting time information of each packet input/output of the output traffic collected from the performance measurement unit and registering the time information as learning data; and
generating a node model of the node by learning a time required for packet processing in the node under a predetermined condition on a basis of the time information.
